(19) United States
(12) Patent Application Publication
(10) Pub. No.: US 2014/0347312 A1
(43) Pub. Date: Nov. 27, 2014

(54) Method for Rejecting a Touch-Swipe Gesture as an Invalid Touch

(71) Applicant: Andrew Siska, San Jose, CA (US)

(72) Inventor: Andrew Siska, San Jose, CA (US)

(21) Appl. No.: 13/901,873

(22) Filed: May 24, 2013

(51) Int. Cl. G06F 3/044

(52) U.S. Cl. CPC G06F 3/044
USPC 345/174

(57) ABSTRACT

In one embodiment, a method for rejecting a touch-swipe gesture as an invalid touch includes receiving a signal indicating a touch-swipe gesture on a display coupled to a touch sensor operable to detect touch input, the touch sensor having a first capacitive node and a second capacitive node surrounding at least a portion of the first capacitive node. The method also includes detecting that the touch-swipe gesture activated the second capacitive node and, in response to the touch-swipe gesture activating the second capacitive node, rejecting the touch-swipe gesture as an invalid touch.

### TECHNICAL FIELD

This disclosure generally relates to touch sensors, and more particularly to a method for rejecting a touch-swipe gesture as an invalid touch.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive-display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine the position of the change in capacitance on the touch screen.

### BRIEF DESCRIPTION OF THE DRAWINGS

FIG. 1 illustrates an example touch sensor with an example touch-sensor controller, according to certain embodiments of the present disclosure;

FIG. 2A illustrates a first example of a first capacitive node and second capacitive node for rejecting a touch-swipe gesture as an invalid touch;

FIG. 2B illustrates a second example of a first capacitive node and second capacitive node for rejecting a touch-swipe gesture as an invalid touch;

FIG. 3 is a flow chart illustrating an example method for rejecting a touch-swipe gesture as an invalid touch;

FIG. 4 is a flow chart illustrating an example method for detecting a home key activation and rejecting invalid touches; and

FIG. 5 is a flow chart illustrating an example method for detecting a slider key activation and rejecting invalid touches.

### DESCRIPTION OF EXAMPLE EMBODIMENTS

In particular embodiments of a touch sensor, the touch sensor may be configured to detect various user touches, such as a touch-swipe gesture, a single touch, or multiple simultaneous touches. Often, a user may accidentally touch or swipe the touch screen causing an unwanted activation of a touch sensor, which may result in launching an application, placing a telephone call, or sending an e-mail, for example. Accordingly, aspects of the present disclosure include a method to reject a touch-swipe gesture as an invalid touch. A second capacitive node surrounding at least a portion of a first capacitive node may detect that a touch-swipe gesture activated the second capacitive node. Once the second capacitive node is activated, the touch-swipe gesture is rejected as an invalid touch.

In an embodiment, the second capacitive node may be spaced approximately two to four millimeters apart from the first capacitive node. One advantage of this spacing is that the distance is small enough to prevent accidental touches. Spacing the first and second capacitive nodes too far apart may result in reduced detection of invalid touches because the user may accidentally touch the first capacitive node without ever activating the second capacitive node due to the large spacing. Another advantage of the spacing is that the distance is large enough for a user to easily make an intentional, valid touch. Spacing the first and second capacitive nodes too close can increase the frequency of invalid touches and cause a user to become frustrated when attempting to purposefully activate the capacitive node. In certain embodiments, the second capacitive node may have a sensitivity greater than the first capacitive node, which increases the likelihood that an invalid touch is detected.

In an embodiment, a home key sensor may be implemented within a center zone of a slider sensor. In certain embodiments, a device may generate a home key activation detect output if the device detects a user gesture in a center zone of a slider sensor that remains stable in the center zone for a predetermined period of time. For example, a user may touch and hold his finger in the center zone for a period of time exceeding the predetermined period of time thereby activating the home key sensor. In another embodiment, the device may also generate a slider activation detect output if the device detects that the user performed a touch-swipe gesture that activated more than one zone of the slider sensor without activating a second capacitive node surrounding at least a portion of the slider sensor. In either embodiment, if the user's gesture also contacts the second capacitive node, then no home key activation or slider activation detect output is generated.

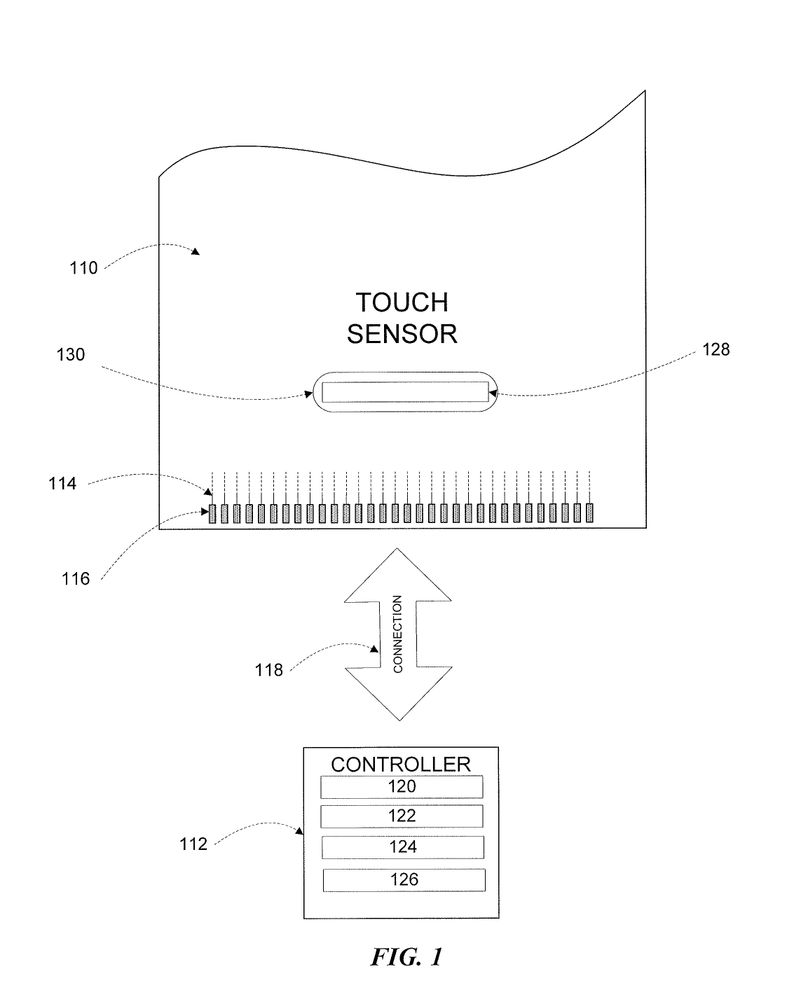

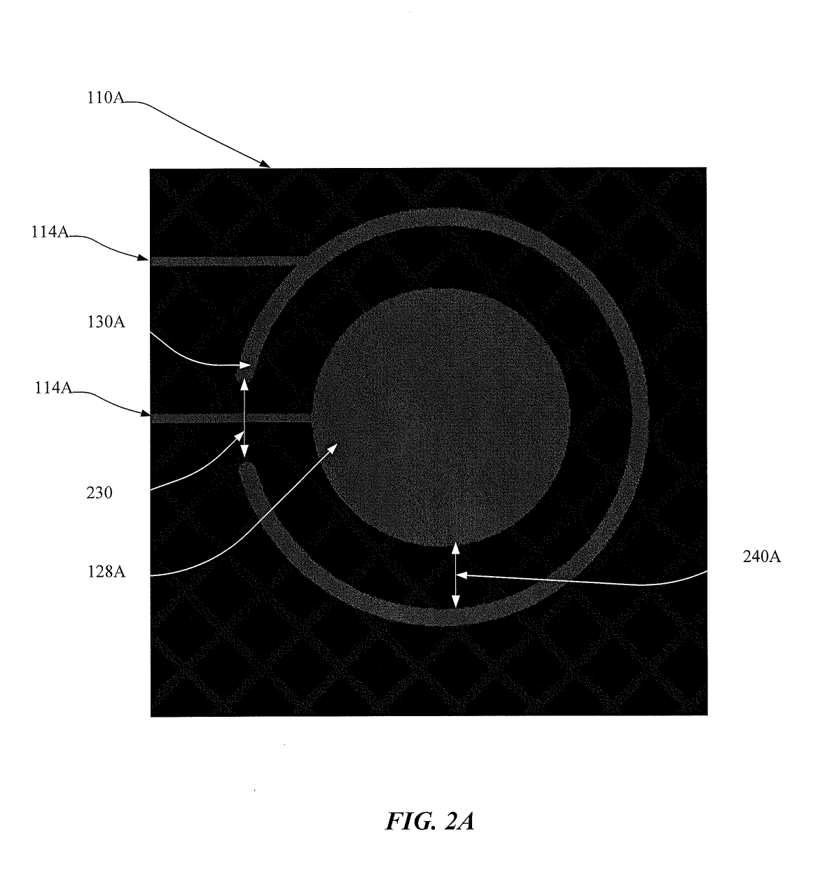

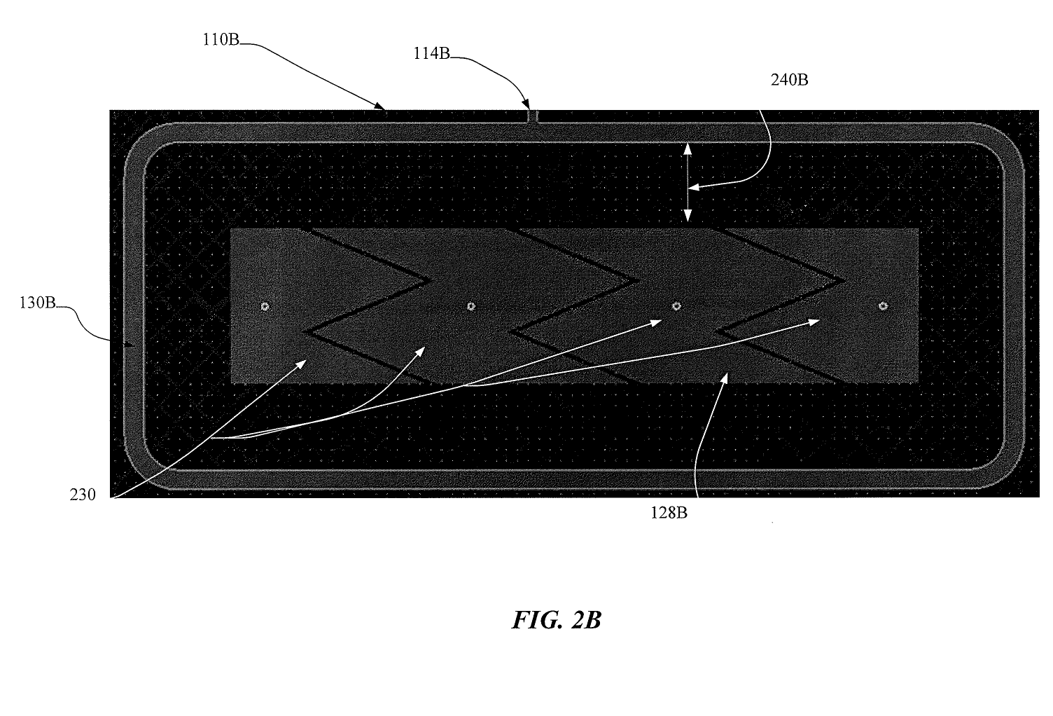

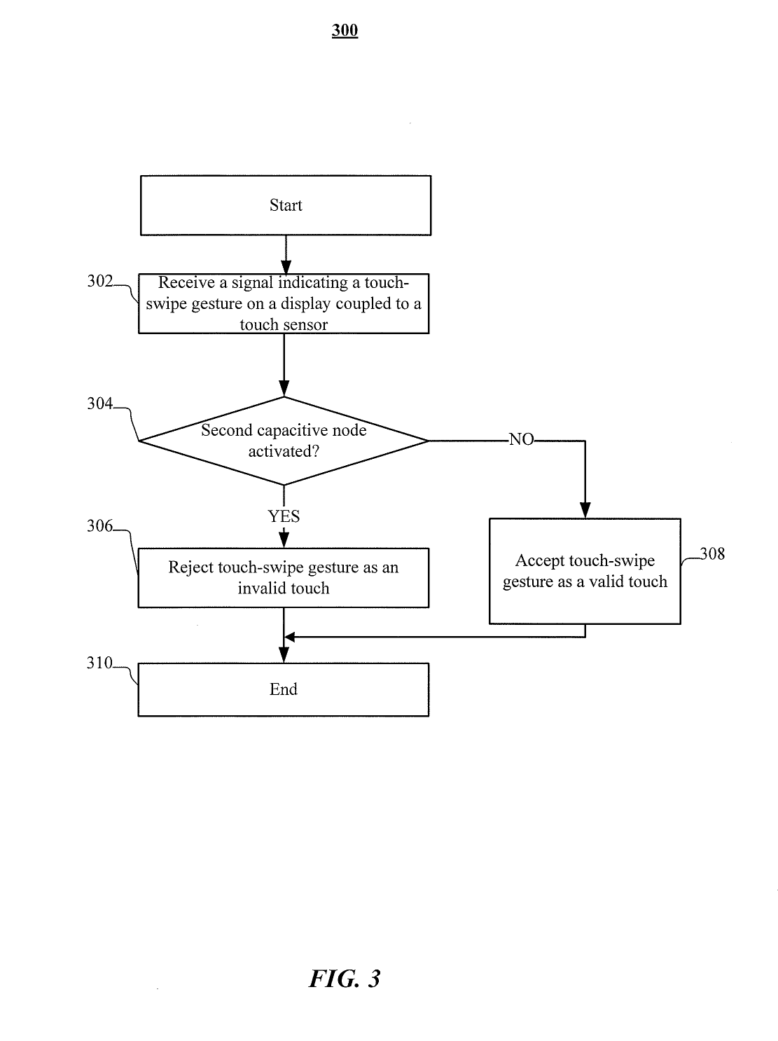

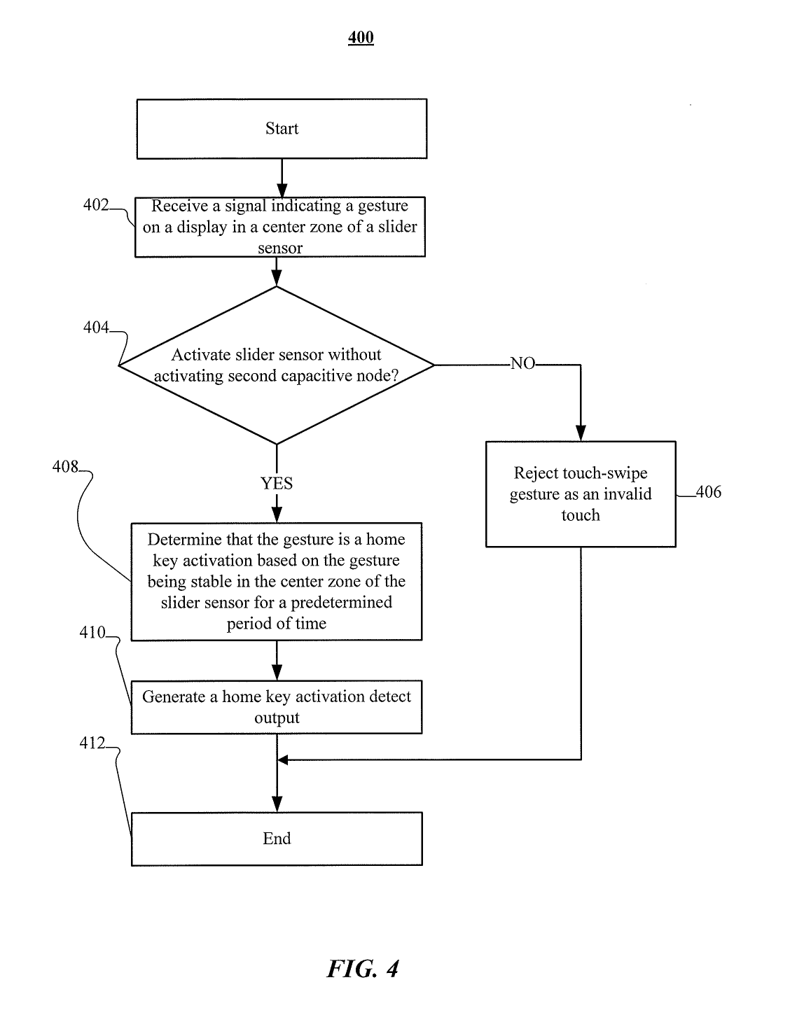

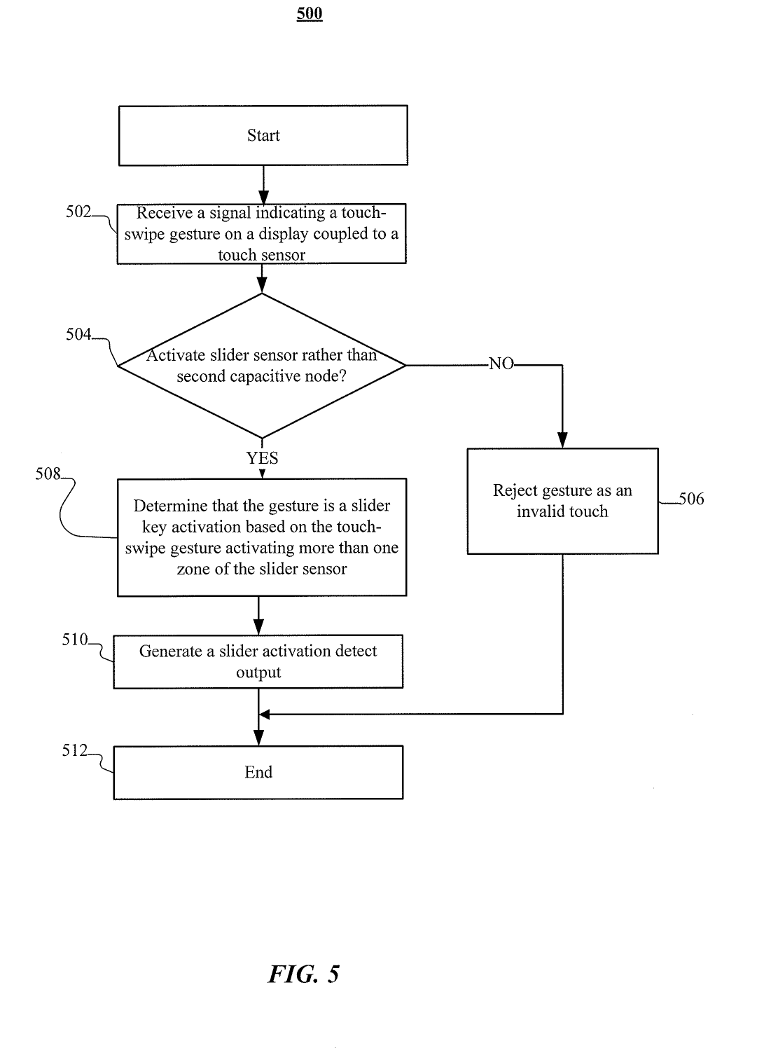

FIG. 1 illustrates an example touch sensor having first capacitive node 128 and second capacitive node 130 for rejecting invalid touches. FIG. 2A illustrates an example configuration of first capacitive node 128 and second capacitive node 130. FIG. 2B illustrates a second example configuration of first capacitive node 128 and second capacitive node 130. FIG. 3 is a flow chart illustrating an example method for rejecting a touch-swipe gesture as an invalid touch. FIG. 4 is a flow chart illustrating an example method for detecting a home key activation and rejecting invalid touches. FIG. 5 is a flow chart illustrating an example method for detecting a slider key activation and rejecting invalid touches.

FIG. 1 illustrates an example touch sensor 110 with an example touch-sensor controller 112, according to certain embodiments of the present disclosure. Touch sensor 110 and touch-sensor controller 112 may detect the presence and location of a touch or the proximity of an object within a touch-sensitive area of touch sensor 110. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 110 may include one or more touch-sensitive areas, where appropriate. For example, touch sensor 110 may include first capacitive node 128 and second capacitive node 130 as will be described below. Touch sensor 110 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a ground electrode, a guard electrode, a drive electrode, or a sense electrode) may be an area of conductive material forming a shape, such as for example a disc, square, rectangle, thin line, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape (sometimes referred to as 100% fill), where appropriate. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fill percentages having particular patterns, this disclosure contemplates any suitable electrodes made of any suitable conductive material forming any suitable shapes with any suitable fill percentages having any suitable patterns.

Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 110. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 110 and touch-sensor controller 112. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 110 may be made of polyethylene terephthalate (PET) or another suitable material. This disclosure contemplates any suitable substrate with any suitable portions made of any suitable material. In particular embodiments, the drive or sense electrodes in touch sensor 110 may be made of ITO in whole or in part. In particular embodiments, the drive or sense electrodes in touch sensor 110 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 110 may implement a capacitive form of touch sensing. In a mutual-capacitance implementation, touch sensor 110 may include an array of drive and sense electrodes forming an array of capacitive nodes. A drive electrode and a sense electrode may form capacitive node 128 or 130. The drive and sense electrodes forming capacitive node 128 or 130 may come near each other, but not make electrical contact with each other. Instead, the drive and sense electrodes may be capacitively coupled to each other across a space between them. A pulsed or alternating voltage applied to the drive electrode (by touch-sensor controller 112) may induce a charge on the sense electrode, and the amount of charge induced may be susceptible to external influence (such as a touch or the proximity of an object). When an object touches or comes within proximity of capacitive node 128 or 130, a change in capacitance may occur at capacitive node 128 or 130 and touch-sensor controller 112 may measure the change in capacitance. By measuring changes in capacitance throughout the array, touch-sensor controller 112 may determine the position of the touch or proximity within the touch-sensitive area(s) of touch sensor 110.

In a self-capacitance implementation, touch sensor 110 may include an array of electrodes of a single type that may each form capacitive node 128 or 130. When an object touches or comes within proximity of capacitive node 128 or 130, a change in self-capacitance may occur at capacitive node 128 or 130 and touch-sensor controller 112 may measure the change in capacitance, for example, as a change in the amount of charge needed to raise the voltage at capacitive node 128 or 130 by a pre-determined amount. As with a mutual-capacitance implementation, by measuring changes in capacitance throughout the array, touch-sensor controller 112 may determine the position of the touch or proximity within the touch-sensitive area(s) of touch sensor 110. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 110 may have drive and sense electrodes disposed in a pattern on one side of a single substrate. In such a configuration, a pair of drive and sense electrodes capacitively coupled to each other across a space between them may form capacitive node 128 or 130. For a self-capacitance implementation, electrodes of only a single type may be disposed in a pattern on a single substrate. In addition or as an alternative to having drive and sense electrodes disposed in a pattern on one side of a single substrate, touch sensor 110 may have drive electrodes disposed in a pattern on one side of a substrate and sense electrodes disposed in a pattern on another side of the substrate. Moreover, touch sensor 110 may have drive electrodes disposed in a pattern on one side of one substrate and sense electrodes disposed in a pattern on one side of another substrate. In such configurations, an intersection of a drive electrode and a sense electrode may form capacitive node 128 or 130. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at capacitive node 128 or 130 of touch sensor 110 may indicate a touch or proximity input at the position of capacitive node 128 or 130. Touch-sensor controller 112 may detect and process the change in capacitance to determine the presence and location of the touch or proximity input. Touch-sensor controller 112 may then communicate information about the touch or proximity input to one or more other components (such one or more central processing units (CPUs)) of a device that includes touch sensor 110 and touch-sensor controller 112, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 112 may be one or more integrated circuits (ICs), such as for example general-purpose microprocessors, microcontrollers, programmable logic devices or arrays, application-specific ICs (ASICs). In particular embodiments, touch-sensor controller 112 comprises analog circuitry, digital logic, and digital non-volatile memory. In particular embodiments, touch-sensor controller 112 is disposed on a flexible printed circuit (FPC) bonded to the substrate of touch sensor 110, as described below. The FPC may be active or passive, where appropriate. In particular embodiments, multiple touch-sensor controllers 112 are disposed on the FPC. Touch-sensor controller 112 may include a processor unit 120, a drive unit 122, a sense unit 124, and a storage unit 126. Drive unit 122 may supply drive signals to the drive electrodes of touch sensor 110. Sense unit 124 may sense charge at capacitive nodes 128 or 130 of touch sensor 110 and provide measurement signals to processor unit 120 representing capacitances at capacitive nodes 128 or 130. Processor unit 120 may control the supply of drive signals to the drive electrodes by drive unit 122 and process measurement signals from sense unit 124 to detect and process the presence and location of a touch or proximity input within the touch-sensitive area(s) of touch sensor 110. Processing measurement signals may include filtering, calculating gradients, and restructuring the measurement signals to more accurately represent the touch or proximity input. The processor unit may also track changes in the position of a touch or proximity input within the touch-sensitive area(s) of touch sensor 110. Storage unit 126 may store programming for execution by processor unit 120, including programming for controlling drive unit 122 to supply drive signals to the drive electrodes, programming for processing measurement signals from sense unit 124, and other suitable programming, where appropriate. Although this disclosure describes a particular touch-sensor controller having a particular implementation with particular components, this disclosure contemplates any suitable touch-sensor controller having any suitable implementation with any suitable components.

Tracks 114 of conductive material disposed on the substrate of touch sensor 110 may couple the drive or sense electrodes of touch sensor 110 to connection pads 116, also disposed on the substrate of touch sensor 110. As described below, connection pads 116 facilitate coupling of tracks 114 to touch-sensor controller 112. Tracks 114 may extend into or around (e.g. at the edges of) the touch-sensitive area(s) of touch sensor 110. Particular tracks 114 may provide drive connections for coupling touch-sensor controller 112 to drive electrodes of touch sensor 110, through which drive unit 122 of touch-sensor controller 112 may supply drive signals to the drive electrodes. Other tracks 114 may provide sense connections for coupling touch-sensor controller 112 to sense electrodes of touch sensor 110, through which sense unit 124 of touch-sensor controller 112 may sense charge at capacitive nodes 128 or 130 of touch sensor 110. Tracks 114 may be made of fine lines of metal or other conductive material. As an example and not by way of limitation, the conductive material of tracks 114 may be copper or copper-based and have a width of approximately 100 μm or less. As another example, the conductive material of tracks 114 may be silver or silver-based and have a width of approximately 100 μm or less. In particular embodiments, tracks 114 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 114, touch sensor 110 may include one or more ground lines terminating at a ground connector (which may be a connection pad 116) at an edge of the substrate of touch sensor 110 (similar to tracks 114).

Connection pads 116 may be located along one or more edges of the substrate, outside the touch-sensitive area(s) of touch sensor 110. As described above, touch-sensor controller 112 may be on an FPC. Connection pads 116 may be made of the same material as tracks 114 and may be bonded to the FPC using an anisotropic conductive film (ACF). Connection 118 may include conductive lines on the FPC coupling touch-sensor controller 112 to connection pads 116, in turn coupling touch-sensor controller 112 to tracks 114 and to the drive or sense electrodes of touch sensor 110. In another embodiment, connection pads 116 may be connected to an electro-mechanical connector (such as a zero insertion force wire-to-board connector); in this embodiment, connection 118 may not need to include an FPC. This disclosure contemplates any suitable connection 118 between touch-sensor controller 112 and touch sensor 110.

Touch sensor 110 may include first capacitive node 128 and second capacitive node 130 for detecting touches. In a mutual-capacitance implementation, first capacitive node 128 and second capacitive node 130 may be formed by an array of drive and sense electrodes. In a self-capacitance implementation, first capacitive node 128 and second capacitive node 130 may be formed by an array of electrodes of a single type. Once first capacitive node 128 or second capacitive node 130 detect a touch, a signal indicating the touch is communicated to touch-sensor controller 112. As depicted in FIG. 1, second capacitive node 130 may surround at least a portion of first capacitive node 128. As described more fully below, second capacitive node 130 may be used to reject accidental touch-swipe gestures as invalid touches. FIGS. 2A and 2B illustrate example configurations of first capacitive node 128 and second capacitive node 130.

FIG. 2A illustrates a first example of a first capacitive node and second capacitive node for rejecting a touch-swipe gesture as an invalid touch. As discussed above, first capacitive node 128A and second capacitive node 130A may be formed by an array of electrodes of a single type. In an embodiment, first capacitive node 128A may be used to implement functionality of an application or operating system, while second capacitive node 130A may be used to detect invalid touches. For example, first capacitive node 128A may be used as a touch-sensitive button controlling any functionality of an application, while second capacitive node 130A may be used to prevent unwanted or accidental touches. As another example, first capacitive node 128A may be used as a home key sensor as required by some operating systems, such as Microsoft Windows 8®, while second capacitive node 130A may be used to prevent an accidental touch from activating the home key sensor. Generally, a home key sensor may be used to “wake” a device that is in stand-by mode or to return a device to its home desktop.

First capacitive node 128A may be formed in any shape desired. For example, first capacitive node 128A may be a circle, semi-circle, square, rectangle, triangle, or any other shape. Although second capacitive node 130A may also be formed in any shape desired, second capacitive node 130A should generally be similar in shape to first capacitive node 128A. In an embodiment, first capacitive node 128A may be any size. However, the proper size of first capacitive node 128A is generally set by the size of a fingertip. If first capacitive node 128A is too small, then a user would have to be very accurate with his fingertip for first capacitive node 128A to detect a touch. In some instances, a first capacitive node 128A that is too small may result in a frustrating user experience due to the perceived lack of response to a deliberate touch. Conversely, if first capacitive node 128A is too large, first capacitive node 128A would detect unwanted touches, such as when a finger is placed in near proximity to first capacitive node 128A, but not directly on first capacitive node 128A.

Second capacitive node 130A may surround at least a portion of first capacitive node 128A in certain embodiments. For example, FIG. 2A depicts an example in which second capacitive node 130A surrounds first capacitive node 128A nearly 360 degrees. One advantage of surrounding first capacitive node nearly 360 degrees is to increase the likelihood that accidental touch-swipe gestures are detected. If second capacitive node 130A includes large openings, then accidental touch-swipe gestures may go undetected because the user's fingertip may never contact second capacitive node 130A. As another example, second capacitive node 130A may include multiple spacings 240A rather than a single spacing 240A. In that example, and as discussed below, each spacing 240A may be small enough such that a fingertip may not slide through spacing 240A thereby causing an accidental touch. As yet another example, second capacitive node 130A may fully enclose first capacitive node 128A to provide 360 degrees of coverage.

Configurations of first capacitive node 128A and second capacitive node 130A may include spacing 240A between first capacitive node 128A and second capacitive node 130A in some embodiments. First capacitive node 128A may be spaced approximately two to four millimeters apart from second capacitive node 130A in an embodiment. For example, if first capacitive node 128A has a diameter of seven millimeters, then second capacitive node 130A may have a diameter of eleven millimeters. If spacing 240A between first capacitive node 128A and second capacitive node 130A is less than two millimeters, then deliberate touches of first capacitive node 128A may not be detected because the user may also activate second capacitive node 130A thereby resulting in an invalid touch. However, if spacing 240A is greater than four millimeters, then accidental touches of first capacitive node 128A may be detected because the user may accidentally touch or swipe first capacitive node 128A without activating second capacitive node 130A thereby resulting in an unwanted activation of first capacitive node 128A.

First capacitive node 128A and second capacitive node 130A may connect to touch-sensor controller 112 by track 114A. As discussed above, track 114A may be any line capable of communicating a detected touch back to touch-sensor controller 112. In an embodiment, second capacitive node 130A may include gap 230 that allows track 114A to connect first capacitive node 128A to touch-sensor controller 112 without crossing second capacitive node 130A. Track 114A connected to first capacitive node 128A may be a separate track than track 114A connected to second capacitive node 130A in certain embodiments. One advantage of including gap 230 is that it allows the use of a single sided printed circuit board, which makes the layout of the board less complicated. In an embodiment, gap 230 may be small enough such that a fingertip cannot fit through spacing gap 230 without activating second capacitive node 130A. Because track 114A is sensitive to touches, track 114A connecting to first capacitive node 128A may, in some embodiments, run in close proximity to track 114A connecting to second capacitive node 130A to avoid unwanted touch detections when a user touches any track. For example, tracks may be spaced approximately 0.5-1.0 mm apart.

In an example embodiment of operation of first capacitive node 128A and second capacitive node 130A, a user may perform a touch-swipe or other gesture on a display coupled to touch sensor 110A. If the user's touch-swipe gesture contacts second capacitive node 130A prior to contacting first capacitive node 128A, touch-sensor controller 112 determines that the user activated second capacitive node 130A and rejects the touch-swipe gesture as an invalid touch. As another example, if the user's touch-swipe gesture contacts first capacitive node 128A and subsequently contacts second capacitive node 130A, touch-sensor controller 112 determines that the user activated second capacitive node 130A and rejects the touch-swipe gesture as an invalid touch. As yet another example, if the user's palm touches both first capacitive node 128A and second capacitive node 130A, touch-sensor controller 112 determines that the user activated second capacitive node 130A and rejects the touch-swipe gesture as an invalid touch. However, if the user touches first capacitive node 128A without contacting second capacitive node 130A, touch-sensor controller 112 may determine that the touch is valid and generate a detect output.

FIG. 2B illustrates a second example of a first capacitive node and second capacitive node for rejecting a touch-swipe gesture as an invalid touch. FIG. 2A and FIG. 2B depict separate example configurations of first capacitive node and second capacitive node, but may include similar elements, such as first and second capacitive nodes, and links coupling the first and second capacitive nodes with controller 112. However, the example configuration of FIG. 2B illustrates second capacitive node 130B fully enclosing first capacitive node 128A whereas FIG. 2A illustrates second capacitive node 130A surrounding a portion of first capacitive node 128A. Additionally, FIG. 2B illustrates an example of implementing first capacitive node 128B as a slider sensor whereas FIG. 2A illustrates an example of implementing first capacitive node 128A as a home key sensor.

First capacitive node 128B may be rectangular in shape such that it may be used as a slider sensor in an embodiment. Generally, slider sensors may be used to implement a variety of application features, such as volume, brightness, unlocking a device, or any other feature. For example, a user may perform a touch-swipe gesture on a display within the area defined as a slider sensor to increase the volume of a device. As discussed above, second capacitive node 130B may also be any shape or size, but should generally be similar in shape to first capacitive node 128B. As an example, if first capacitive node 128B is implemented as a rectangular slider sensor as depicted in FIG. 2B, then second capacitive node 130B may also be substantially rectangular in shape.

Configurations of first capacitive node 128A and second capacitive node 130B may include spacing 240B between first capacitive node 128B and second capacitive node 130B in some embodiments. First capacitive node 128B and second capacitive node 130B may be spaced approximately two to four millimeters apart in an embodiment. As noted above, two to four millimeters of spacing 240B may result in the proper rejection of invalid touches while maintaining the user's ability to intentionally activate first capacitive node 128B. For example, if spacing 240B is less than two millimeters, then a user may attempt to intentionally swipe the slider sensor, but instead activate second capacitive node 130B. As another example, if spacing 240B is greater than four millimeters, then a user may accidentally swipe the slider sensor without activating second capacitive node 130B thereby causing an unwanted activation of the slider sensor.

Second capacitive node 130B may surround at least a portion of first capacitive node 128B in an embodiment. In other embodiments, and as the example embodiment of FIG. 2B depicts, second capacitive node 130B may entirely enclose first capacitive node 128B. One advantage of entirely enclosing first capacitive node 128B is to ensure that the user cannot accidentally swipe through an open space between first capacitive node 128B and second capacitive node 130B. However, entirely enclosing first capacitive node 128B with second capacitive node 130B may require the use of a double sided printed circuit board such that track 114B connected to second capacitive node 130B does not cross the track (not depicted) coupled to first capacitive node 128B. Although FIG. 2B illustrates second capacitive node 130B fully surrounding first capacitive node 128A, second capacitive node 130B may include various gaps (as illustrated in FIG. 2A). For example, second capacitive node 130B may surround first capacitive node 128B 360 degrees, but may include small gaps every 90 degrees. In that example, the gaps may be small enough that a fingertip cannot slide through the gaps without activating second capacitive node 130B, which increases the likelihood that an accidental touch may be detected.

First capacitive node 128B may form a slider sensor in certain embodiments, which may include multiple zones 230. Having multiple zones 230 enables touch-sensor controller 112 to distinguish between a slider activation and a home key activation. In an embodiment, the slider sensor may be programmed to include three separate zones 230. For example, a finger placed on the left-most zone of the slider sensor will be reported as position zero, a finger placed in the center zone will be reported as position 128, and a finger placed on the right-most zone will be reported as position 256. In some embodiments, a home key activation is distinguished from a slider activation based on the position and stability or movement of the finger. For example, a slider activation may occur when the user places his finger on the left-most zone and swipes across more than one zone. Once touch-sensor controller 112 determines that the user activated more than one zone of the slider sensor without activating second capacitive node 130B, touch-sensor controller 112 generates a slider key activation detect output. However, a home key activation may occur when the user places his finger into the center zone and remains stable for a predetermined period of time without also activating second capacitive node 130B. In that situation, touch-sensor controller 112 may then generate a home key activation detect output. In some embodiments, a predetermined period of time may be long enough so that a user does not accidentally trigger the home key sensor by briefly placing his finger over the center zone of the home key or center zone of a slider sensor. In some embodiments, a predetermined period of time may be between approximately 50 to 100 milliseconds.

In an example embodiment of operation of first capacitive node 128B and second capacitive node 130B, a user may perform a touch-swipe gesture on touch screen 110B. If the user's touch-swipe gesture contacts second capacitive node 130B prior to contacting first capacitive node 128B, touch-sensor controller 112 determines that the user activated second capacitive node 130B and rejects the touch-swipe gesture as an invalid touch. As another example, if the user's touch-swipe gesture contacts first capacitive node 128B and subsequently contacts second capacitive node 130B, touch-sensor controller 112 determines that the user activated second capacitive node 130B and rejects the touch-swipe gesture as an invalid touch. As yet another example, if the user's palm touches both first capacitive node 128B and second capacitive node 130B, touch-sensor controller 112 determines that the user activated second capacitive node 130B and rejects the touch-swipe gesture as an invalid touch. However, if the user's touch-swipe gesture activates more than one zone of first capacitive node 128B without activating second capacitive node 130B, touch-sensor controller 112 generates a slider activation detect output. If the user touches the center zone of zones 230 without activating second capacitive node 130B, and the user's finger remains stable for a predetermined period of time, then touch-sensor controller 112 generates a home key activation detect output.

FIG. 3 is a flow chart illustrating an example method for rejecting a touch-swipe gesture as an invalid touch. At step 302, touch-sensor controller 112 receives a signal indicating that a touch-swipe gesture on a display coupled to touch sensor 110. At step 304, touch-sensor controller 112 may determine whether the touch-swipe gesture activated second capacitive node 130. In an embodiment, touch-sensor controller 112 may determine if the touch-swipe gesture activated second capacitive node 130 based on receiving a signal from second capacitive node 130. For example, if the user's touch-swipe gesture contacted second capacitive node 130 prior to contacting first capacitive node 128, then second capacitive node 130 may communicate a signal to touch-sensor controller 112 indicating that the user activated second capacitive node 130. As another example, if the user's touch-swipe gesture contacts first capacitive node 128 and subsequently contacts second capacitive node 130, then second capacitive node 130 may communicate a signal to touch-sensor controller 112 indicating that the user activated second capacitive node 130. If touch-sensor controller 112 determines that the touch-swipe gesture activated second capacitive node 130, then the method proceeds to step 306 where touch-sensor controller 112 may reject the touch-swipe gesture as an invalid touch. If touch-sensor controller 112 rejects the touch-swipe gesture, touch-sensor controller 112 may not generate any detect outputs.

If touch-sensor controller 112 determines that the touch-swipe gesture did not activate second capacitive node 130, then the method proceeds to step 308 where touch-sensor controller 112 may determine that the touch-swipe gesture is a valid touch. For example, if the user's touch-swipe gesture contacted first capacitive node 128 without contacting second capacitive node 130, then first capacitive node 128 may communicate a signal to touch-sensor controller 112 indicating that the user activated first capacitive node 128. In some embodiments, touch-sensor controller 112 will generate a home key activation detect output or a slider activation detect output based on a valid touch determination. At step 310, the method ends. Method 300 illustrates an example method for rejecting a touch-swipe gesture as an invalid touch. Modifications, additions, or omissions may be made without departing from the scope of this disclosure. Steps may be combined, modified, or deleted where appropriate, and additional steps may be added.

FIG. 4 is a flow chart illustrating an example method for detecting a home key activation and rejecting invalid touches. At step 402, touch-sensor controller 112 may receive a signal indicating a gesture in a center zone of a slider sensor. For example, a user may press his finger in the center zone of the slider sensor and slider sensor may communicate a signal to touch-sensor controller 112 indicating the touch. At step 404, touch-sensor controller 112 may determine whether the gesture activated the slider sensor or second capacitive node 130. In some embodiments, touch-sensor controller 112 may make this determination based on whether touch-sensor controller 112 received a signal from second capacitive node 130. For example, if a user attempts to activate a home key sensor by placing his finger in a center zone of a slider sensor and accidentally touches second capacitive node 130 along with the home key sensor, then second capacitive node 130 communicates a signal to touch-sensor controller 112. If touch-sensor controller 112 received a signal from second capacitive node 130, then the method proceeds to step 406 where touch-sensor controller 112 may determine that the gesture is an invalid touch. If touch-sensor controller 112 did not receive a signal from second capacitive node 128, the method proceeds to step 408.

At step 408, touch-sensor controller 112 may determine that the gesture is a home key activation. In an embodiment, touch-sensor controller 112 may determine that the gesture is a home key activation based on the gesture being stable in a center zone of the slider sensor for a predetermined period of time. For example, a user may press and hold his finger in the center zone for a period of time that satisfies the predetermined threshold period of time, such as 75 milliseconds. At step 410, touch-sensor controller 112 may generate a home key activation detect output. In an embodiment, the home key activation detect output may cause a device to “wake” or go to the operating system's “home” desktop. At step 412, the method ends. Method 400 illustrates an example method for detecting a home key activation and rejecting invalid touches. Modifications, additions, or omissions may be made without departing from the scope of this disclosure. Steps may be combined, modified, or deleted where appropriate, and additional steps may be added.

FIG. 5 is a flow chart illustrating an example method for detecting a slider key activation and rejecting invalid touches. At step 502, touch-sensor controller 112 receives a signal indicating a touch-swipe gesture on a display coupled to touch sensor 110. At step 504, touch-sensor controller 112 determines if the touch-swipe gesture activated the slider sensor or second capacitive node 130. In certain embodiments, touch-sensor controller 112 may determine that the touch-swipe gesture activated second capacitive node 130 based on receiving a signal from second capacitive node 130 indicating the touch-swipe gesture. For example, if the user attempts to swipe his finger within the area of a slider sensor and accidentally contacts second capacitive node 130, second capacitive node 130 may communicate a signal to touch-sensor controller 112 indicating that the user activated second capacitive node 130. As another example, if the user grabs his phone from his pocket and accidentally swipes across the slider sensor and accidentally contacts second capacitive node 130, second capacitive node 130 may communicate a signal to touch-sensor controller 112. If the touch-swipe gesture activated second capacitive node 130, then the method proceeds to step 506 where the touch-swipe gesture is rejected as an invalid touch. If touch-sensor controller 112 rejects the touch-swipe gesture as an invalid touch, touch-sensor controller 112 may not generate an output. In the two examples above, the inaccurate and accidental swipes would not trigger the feature controlled by the slider sensor. If the touch-swipe gesture activated slider sensor without activating second capacitive sensor 130, then the method proceeds to step 508.

At step 508, touch-sensor controller 112 may determine that the touch-swipe gesture is a slider activation. In an embodiment, touch-sensor controller 112 may make this determination based on the touch-swipe gesture activating more than one zone of the slider sensor. For example, a user may touch his finger on a center zone of the slider sensor and move the finger across to the right-most zone of the slider sensor thereby activating more than one zone of the slider sensor. As another example, the user may touch his finger on the left-most zone of the slider sensor and move his finger across to the center zone of the slider sensor thereby activating more than one zone of the slider sensor. However, if at any time the user's touch-swipe gesture contacts second capacitive node 130, touch-sensor controller 112 may determine that the touch-swipe gesture is an invalid touch based on receiving a signal from second capacitive node 130.

At step 510, touch-sensor controller 112 may generate a slider activation detect output. As discussed above, the slider sensor may control various features of an application, such as volume, brightness, or any other feature. At step 512, the method ends. Method 500 illustrates an example method for detecting a slider key activation and rejecting invalid touches. Modifications, additions, or omissions may be made without departing from the scope of this disclosure. Steps may be combined, modified, or deleted where appropriate, and additional steps may be added.

Certain embodiments of the invention may provide one or more technical advantages. In some embodiments, accidental touch-swipe gestures are rejected as invalid touches thereby preventing the accidental application launch, telephone call, or e-mail. In certain embodiments, accidental touch-swipe gestures may be rejected using first capacitive node 128 and second capacitive node 130 thereby conserving much-needed space within a device. Moreover, second capacitive node 130 may surround at least a portion of first capacitive node 128, which may provide greater detection of invalid touches. In certain embodiments, first capacitive node 128 is spaced approximately two to four millimeters apart from second capacitive node 130 such that accidental touch-swipe gestures are rejected while maintaining the user's ability to purposefully activate first capacitive node 128. Certain embodiments may implement the methods disclosed herein as a stand-alone module without requiring additional information or input.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
receiving a signal indicating a touch-swipe gesture on a display coupled to a touch sensor operable to detect touch input, the touch sensor having a first capacitive node and a second capacitive node surrounding at least a portion of the first capacitive node;
detecting that the touch-swipe gesture activated the second capacitive node; and
in response to the touch-swipe gesture activating the second capacitive node, rejecting the touch-swipe gesture as an invalid touch.

2. The method of claim 1, wherein the second capacitive node has a sensitivity greater than the first capacitive node.

3. The method of claim 1, wherein the first capacitive node is a home key sensor.

4. The method of claim 1, wherein the first capacitive node is a slider sensor.

5. The method of claim 1, wherein the second capacitive node is spaced approximately two millimeters apart from the first capacitive node.

6. The method of claim 4, further comprising:
receiving a signal indicating a second gesture on the display in a center zone of the slider sensor;
detecting that the second gesture activated the slider sensor without activating the second capacitive node;
determining that the second gesture is a home key activation based on the second gesture being stable in the center zone of the slider sensor for a predetermined period of time; and
generating a home key activation detect output.

7. The method of claim 4, further comprising:
receiving a signal indicating a second touch-swipe gesture on the display;
detecting that the second touch-swipe gesture activated the slider sensor without activating the second capacitive node;
determining that the second touch-swipe gesture is a slider activation based on the second touch-swipe gesture activating more than one zone of the slider sensor; and
generating a slider activation detect output.

8. An apparatus comprising:
a display coupled to a touch sensor operable to receive a touch-swipe gesture, the touch sensor having a first capacitive node and a second capacitive node, the second capacitive node surrounding at least a portion of the first capacitive node;
a touch-sensor controller coupled to the touch sensor, the touch sensor controller operable to:
detect that the touch-swipe gesture activated the second capacitive node; and
in response to the touch-swipe gesture activating the second capacitive node, reject the touch-swipe gesture as an invalid touch.

9. The apparatus of claim 8, wherein the second capacitive node has a sensitivity greater than the first capacitive node.

10. The apparatus of claim 8, wherein the second capacitive node entirely encloses the first capacitive node.

11. The apparatus of claim 8, wherein the second capacitive node has a plurality of gaps.

12. The apparatus of claim 8, wherein the first capacitive node is a home key sensor.

13. The apparatus of claim 8, wherein the first capacitive node is a slider sensor.

14. The apparatus of claim 8, wherein the second capacitive node is spaced approximately two millimeters apart from the first capacitive node.

15. The apparatus of claim 13, wherein the display coupled to the touch sensor is further operable to receive a gesture in a center zone of the slider sensor;
the touch-sensor controller further operable to:
detect that the gesture activated the slider sensor without activating the second capacitive node;
determine that the gesture is a home key activation based on the gesture being stable in the center zone of the slider sensor for a predetermined period of time; and
generate a home key activation detect output.

16. The apparatus of claim 13, wherein the display coupled to the touch sensor is further operable to receive a second touch-swipe gesture;
the touch-sensor controller further operable to:
detect that the second touch-swipe gesture activated the slider sensor without activating the second capacitive node;
determine that the second touch-swipe gesture is a slider activation based on the second touch-swipe gesture activating more than one zone of the slider sensor; and
generate a slider activation detect output.

17. One or more computer-readable non-transitory storage media embodying logic that is operable when executed to:
receive a signal indicating a touch-swipe gesture on a display coupled to a touch sensor operable to detect touch input, the touch sensor having a first capacitive node and a second capacitive node surrounding at least a portion of the first capacitive node;
detect that the touch-swipe gesture activated the second capacitive node; and
in response to the touch-swipe gesture activating the second capacitive node, rejecting the touch-swipe gesture as an invalid touch.

18. The media of claim 17, wherein the second capacitive node has a sensitivity greater than the first capacitive node.

19. The media of claim 17, wherein the first capacitive node is a home key sensor.

20. The media of claim 17, wherein the first capacitive node is a slider sensor.

21. The media of claim 17, wherein the second capacitive node is spaced approximately two millimeters apart from the first capacitive node.

22. The media of claim 20, wherein the logic is further operable when executed to:
receive a signal indicating a second gesture on the display in a center zone of the slider sensor;
detect that the second gesture activated the slider sensor without activating the second capacitive node;
determine that the second gesture is a home key activation based on the second gesture being stable in the center zone of the slider sensor for a predetermined period of time; and
generate a home key activation detect output.
